(19) United States
(12) Patent Application Publication
(10) Pub. No.: US 2024/0107558 A1
(43) Pub. Date: Mar. 28, 2024

(54) METHOD AND APPARATUS FOR ADAPTIVE SECURITY APPLICATION IN COMMUNICATION SYSTEM

(71) Applicants: HYUNDAI MOTOR COMPANY, SEOUL (KR); KIA CORPORATION, SEOUL (KR)

(72) Inventors: Gene Back Hahn, Hwaseong-si (KR); Seung Wook Park, Hwaseong-si (KR)

(21) Appl. No.: 18/526,830

(22) Filed: Dec. 1, 2023

Related U.S. Application Data
(63) Continuation of application No. PCT/KR22/07655, filed on May 30, 2022.

(30) Foreign Application Priority Data
Jun. 3, 2021 (KR) 10-2021-0072343

(51) Int. Cl. H04W 72/25; H04W 12/06; H04W 12/10; H04W 76/14; H04W 76/20

(52) U.S. Cl. CPC H04W 72/25; H04W 12/06; H04W 12/10; H04W 76/14; H04W 76/20

(57) ABSTRACT

A method for adaptive security application in a communication system comprises determining a security level in consideration of a communication environment, transmitting SCI including information of the security level and scheduling information of data to a second UE, generating the data on the basis of a security function according to the security level, and transmitting the data to the second UE in a resource indicated by the scheduling information.

### CROSS REFERENCE TO RELATED APPLICATIONS

This application is a continuation of International Application PCT/KR2022/007655 filed on May 30, 2022, which claims priority to Korean Patent Application No. KR 10-2021-72343 filed on Jun. 3, 2021, in the Korean Intellectual Property Office, the disclosure of each of which is incorporated by reference herein in its entirety.

### TECHNICAL FIELD

The present disclosure relates to a security technique, and more particularly, to a technique for communication based on an adaptive security level.

### BACKGROUND

A fifth-generation (5G) communication system (e.g., New Radio (NR) communication system) which uses a frequency band higher than a frequency band of a fourth-generation (4G) communication system (e.g., Long Term Evolution (LTE) communication system or LTE-Advanced (LTE-A) communication system) as well as the frequency band of the 4G communication system has been considered for processing of wireless data. The 5G communication system can support Enhanced Mobile Broadband (eMBB) communications, Ultra-Reliable and Low-Latency communications (URLLC), massive Machine Type Communications (mMTC), and the like.

The 4G communication system and 5G communication system can support Vehicle-to-Everything (V2X) communications. The V2X communications supported in a cellular communication system, such as the 4G communication system, the 5G communication system, and the like, may be referred to as “Cellular-V2X (C-V2X) communications.” The V2X communications (e.g., C-V2X communications) may include Vehicle-to-Vehicle (V2V) communications, Vehicle-to-Infrastructure (V2I) communications, Vehicle-to-Pedestrian (V2P) communication, Vehicle-to-Network (V2N) communication, and the like.

Meanwhile, communication may be performed based on a preset security level (e.g., security requirements) in the communication system. When a communication environment changes due to movement of a user equipment (UE), the communication may not be performed efficiently if the preset security level is used without resetting the security level according to the changed communication environment. Therefore, methods for adaptively applying a security level according to the changed communication environment are required.

### SUMMARY

The present disclosure is directed to providing a method and an apparatus for adaptive security application according a communication environment.

A method of operation of a first user equipment (UE), according to a first exemplary embodiment of the present disclosure for achieving the above-described objective, may comprise determining a security level considering a communication environment; transmitting sidelink control information (SCI) including information on the security level and scheduling information of data to a second UE, generating the data based on a security function according to the security level, and transmitting the data to the second UE in a resource indicated by the scheduling information.

The method may further comprise receiving, from a network entity or base station, information indicating activation of use of a flexible security level, wherein when the use of the flexible security level is activated, the security level may be determined considering the communication environment.

The information indicating activation of use of the flexible security level may be received from the network entity in a network access procedure or a network authentication procedure.

The receiving of the information indicating activation of use of the flexible security level may comprise transmitting information indicating initiation of a sidelink service to the base station, and receiving, from the base station, a radio resource control (RRC) message including the information indicating activation of use of the flexible security level.

The method may further comprise transmitting, to the second UE, information indicating use of a flexible security level, wherein the information indicating use of the flexible security level may be transmitted in a link establishment procedure between the first UE and the second UE.

The method may further comprise identifying the communication environment, wherein a mapping relationship between the communication environment and the security level may be configured in advance, and the security level may be determined based on the mapping relationship with the communication environment.

The communication environment may include at least one of a speed of the first UE, a degree of traffic congestion around the first UE, available resources for application of the security function according to the security level, a security level of the first UE, a security level of a service, a security level of a message, or importance of a message.

The security function may include at least one of an encryption function, an integrity function, or an electronic signature function.

The SCI may be classified into first-stage SCI and second-stage SCI, the scheduling information may be included in the first-stage SCI, and the information on the security level may be included in the second-stage SCI associated with the first-stage SCI.

A method of operation of a first UE, according to a second exemplary embodiment of the present disclosure for achieving the above-described objective, may comprise receiving information on a security level from a second UE, transmitting sidelink control information (SCI) including information indicating application of the security level and scheduling information of data to the second UE, generating the data based on a security function according to the security level, and transmitting the data to the second UE in a resource indicated by the scheduling information.

The method may further comprise receiving, from a network entity or base station, information indicating activation of use of a flexible security level, wherein when the use of the flexible security level is activated, sidelink communication based on the security level determined by the second UE may be performed.

The method may further comprise receiving, from the second UE, information indicating use of a flexible security level, wherein the information indicating use of the flexible security level may be received in a link establishment procedure between the first UE and the second UE.

The security level may be determined by the second UE considering a communication environment, and the communication environment may include at least one of a speed of the second UE, a degree of traffic congestion around the second UE, available resources for application of the security function according to the security level, a security level of the second UE, a security level of a service, a security level of a message, or importance of a message.

A method of operation of a second UE, according to a third exemplary embodiment of the present disclosure for achieving the above-described objective, may comprise determining a security level considering a communication environment, transmitting information on the security level to a first UE, receiving sidelink control information (SCI) including information indicating application of the security level and scheduling information of data from the first UE, receiving the data from the first UE in a resource indicated by the scheduling information; and performing a processing operation on the data based on a security function according to the security level.

The method may further comprise receiving, from a network entity or base station, information indicating activation of use of a flexible security level, wherein when the use of the flexible security level is activated, the security level may be determined considering the communication environment.

The information indicating activation of use of the flexible security level may be received from the network entity in a network access procedure or a network authentication procedure.

The receiving of the information indicating activation of use of the flexible security level may comprise transmitting information indicating initiation of a sidelink service to the base station, and receiving, from the base station, a radio resource control (RRC) message including the information indicating activation of use of the flexible security level.

The method may further comprise identifying the communication environment, wherein a mapping relationship between the communication environment and the security level is configured in advance, and the security level may be determined based on the mapping relationship with the communication environment.

The communication environment may include at least one of a speed of the second UE, a degree of traffic congestion around the second UE, available resources for application of the security function according to the security level, a security level of the second UE, a security level of a service, a security level of a message, or importance of a message.

The processing operation may include at least one of a decryption operation, an integrity verification operation, or an electronic signature verification operation.

According to the present disclosure, a transmitting UE or a receiving UE may determine a security level based on a communication environment. That is, in sidelink communication, a security level can be adaptively determined in consideration of the communication environment. The transmitting UE may transmit SCI including information on the security level information and scheduling information to the receiving UE, and may transmit data generated according to the security level to the receiving UE. The receiving UE may receive the SCI from the transmitting UE and may receive the data based on information element(s) included in the SCI. That is, the receiving UE may perform processing operations (e.g., decryption operation, integrity verification operation, and/or electronic signature verification operation) on the data based on the security level. Accordingly, the sidelink communication can be performed efficiently.

### BRIEF DESCRIPTION OF THE FIGURES

FIG. 1 is a conceptual diagram illustrating V2X communication scenarios.

FIG. 2 is a conceptual diagram illustrating an exemplary embodiment of a cellular communication system.

FIG. 3 is a conceptual diagram illustrating an exemplary embodiment of a communication node constituting a cellular communication system.

FIG. 4 is a block diagram illustrating an exemplary embodiment of a user plane protocol stack of a UE performing sidelink communication.

FIG. 5 is a block diagram illustrating a first exemplary embodiment of a control plane protocol stack of a UE performing sidelink communication.

FIG. 6 is a block diagram illustrating a second exemplary embodiment of a control plane protocol stack of a UE performing sidelink communication.

FIG. 7 is a sequence chart illustrating a first exemplary embodiment of a communication method based on a flexible security level.

FIG. 8 is a sequence chart illustrating a second exemplary embodiment of a communication method based on a flexible security level.

### DETAILED DESCRIPTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In exemplary embodiments of the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

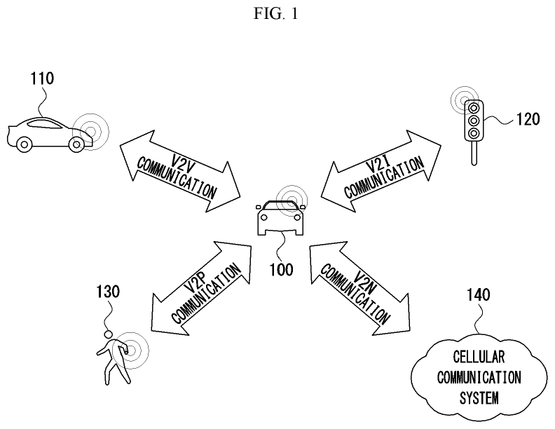

FIG. 1 is a conceptual diagram illustrating V2X communication scenarios.

As shown in FIG. 1, the V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a cellular communication system (e.g., a cellular communication system 140), and the V2X communications supported by the cellular communication system 140 may be referred to as “Cellular-V2X (C-V2X) communications.” Here, the cellular communication system 140 may include the 4G communication system (e.g., LTE communication system or LTE-A communication system), 5G communication system (e.g., NR communication system), 6G communication system, and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported in the cellular communication system 140 may be performed based on “sidelink” communication technologies (e.g., ProSe and D2D communication technologies, and the like). In this case, the communications between the vehicles 100 and 110 may be performed using at least one sidelink channel established between the vehicles 100 and 110.

The V2I communications may include communications between the first vehicle 100 (e.g., the communication node located in the vehicle 100) and an infrastructure (e.g., road side unit (RSU)) 120 located on a roadside. The infrastructure 120 may also include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported in the cellular communication system 140 may also be performed based on sidelink communication technologies (e.g., ProSe and D2D communication technologies, and the like). In this case, the communications between the vehicle 100 and the infrastructure 120 may be performed using at least one sidelink channel established between the vehicle 100 and the infrastructure 120.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported in the cellular communication system 140 may be performed based on sidelink communication technologies (e.g., ProSe and D2D communication technologies, and the like). In this case, the communications between the communication node located in the vehicle 100 and the communication node carried by the person 130 may be performed using at least one sidelink channel established between the communication nodes.

The V2N communications may be communications between the first vehicle 100 (e.g., the communication node located in the vehicle 100) and a server connected through the cellular communication system 140. The V2N communications may be performed based on the 4G communication technology (e.g., LTE or LTE-A) or the 5G communication technology (e.g., NR). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, or a Wireless Personal Area Network (WPAN) communication technology defined in IEEE 802.15.

Meanwhile, the cellular communication system 140 supporting the V2X communications may be configured as follows.

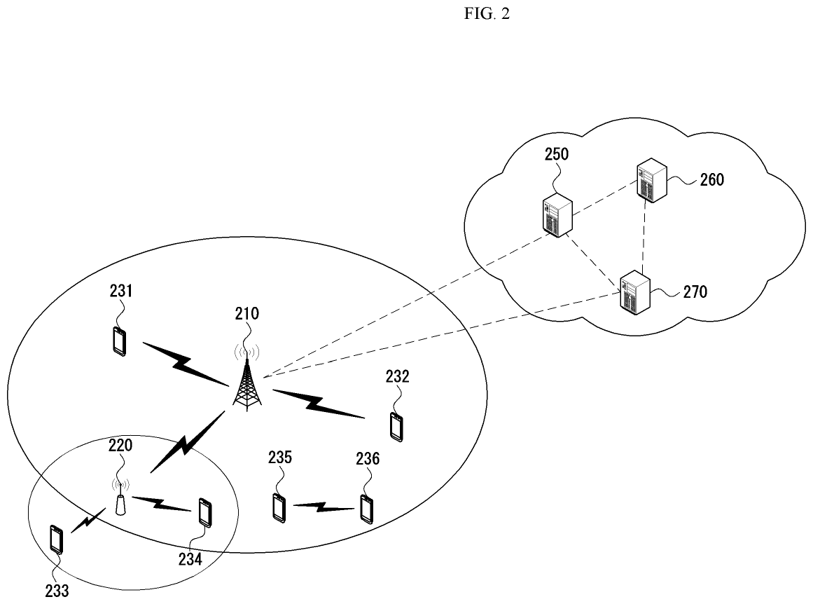

FIG. 2 is a conceptual diagram illustrating an exemplary embodiment of a cellular communication system.

As shown in FIG. 2, a cellular communication system may include an access network, a core network, and the like. The access network may include a base station 210, a relay 220, User Equipments (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the cellular communication system supports the 4G communication technology, the core network may include a serving gateway (S-GW) 250, a packet data network (PDN) gateway (P-GW) 260, a mobility management entity (MME) 270, and the like.

When the cellular communication system supports the 5G communication technology, the core network may include a user plane function (UPF) 250, a session management function (SMF) 260, an access and mobility management function (AMF) 270, and the like. Alternatively, when the cellular communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the cellular communication system supports a network slicing technique, the core network may be divided into a plurality of logical network slices. For example, a network slice supporting V2X communications (e.g., a V2V network slice, a V2I network slice, a V2P network slice, a V2N network slice, etc.) may be configured, and the V2X communications may be supported through the V2X network slice configured in the core network.

The communication nodes (e.g., base station, relay, UE, S-GW, P-GW, MME, UPF, SMF, AMF, etc.) comprising the cellular communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, etc.) comprising the cellular communication system may be configured as follows.

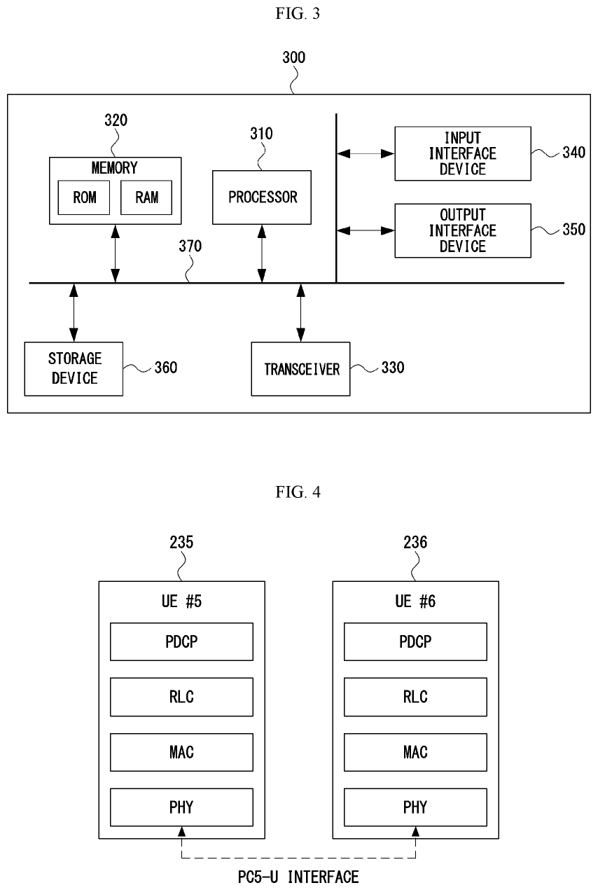

FIG. 3 is a conceptual diagram illustrating an exemplary embodiment of a communication node constituting a cellular communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one instruction stored in at least one of the memory 320 and the storage device 360. The processor 310 may refer to a central processing unit (CPU), a graphics processing unit (GPU), or a dedicated processor on which methods in accordance with embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input, multiple-output (MIMO) technologies (e.g., single user (SU)-MIMO, multi-user (MU)-MIMO, massive MIMO, etc.), coordinated multipoint (CoMP) communication technologies, carrier aggregation (CA) communication technologies, unlicensed band communication technologies (e.g., Licensed Assisted Access (LAA), enhanced LAA (eLAA), etc.), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), an evolved Node B (eNB), a base transceiver station (BTS), a radio remote head (RRH), a transmission reception point (TRP), a radio unit (RU), a roadside unit (RSU), a radio transceiver, an access point, an access node, or the like. The relay 220 may be referred to as a small base station, a relay node, or the like. Each of the UEs 231 through 236 may be referred to as a terminal, an access terminal, a mobile terminal, a station, a subscriber station, a mobile station, a portable subscriber station, a node, a device, an on-broad unit (OBU), or the like.

Meanwhile, the communications between the UEs 235 and 236 may be performed based on the sidelink communication technique. The sidelink communications may be performed based on a one-to-one scheme or a one-to-many scheme. When V2V communications are performed using the sidelink communication technique, the UE 235 may be the communication node located in the first vehicle 100 of FIG. 1 and the UE 236 may be the communication node located in the second vehicle 110 of FIG. 1. When V2I communications are performed using the sidelink communication technique, the UE 235 may be the communication node located in first vehicle 100 of FIG. 1 and the UE 236 may be the communication node located in the infrastructure 120 of FIG. 1. When V2P communications are performed using the sidelink communication technique, the UE 235 may be the communication node located in first vehicle 100 of FIG. 1 and the UE 236 may be the communication node carried by the person 130 of FIG. 1.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage | Out of coverage |
| | of base station 210 | of base station 210 |
| B | In coverage of | Out of coverage of |
| | base station 210 | base station 210 |
| C | In coverage of | In coverage of |
| | base station 210 | base station 210 |
| D | In coverage of | In coverage of |
| | base station 210 | other base station |

Meanwhile, a user plane protocol stack of the UEs (e.g., the UEs 235 and 236) performing sidelink communications may be configured as follows.

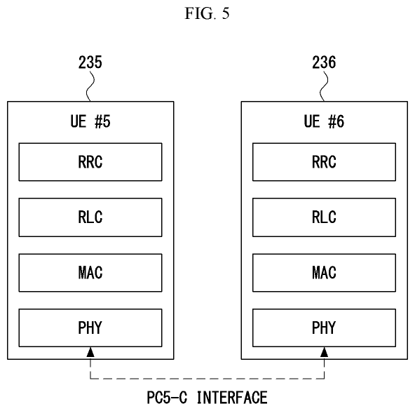

FIG. 4 is a block diagram illustrating an exemplary embodiment of a user plane protocol stack of a UE performing sidelink communication.

As shown in FIG. 4, a left UE may be the UE 235 shown in FIG. 2 and a right UE may be the UE 236 shown in FIG. 2. The scenario for the sidelink communications between the UEs 235 and 236 may be one of the sidelink communication scenarios A through D of Table 1.

The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID) may be an ID configured for the V2X communications (e.g., V2X service). Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g., the UEs 235 and 236) performing sidelink communications may be configured as follows.

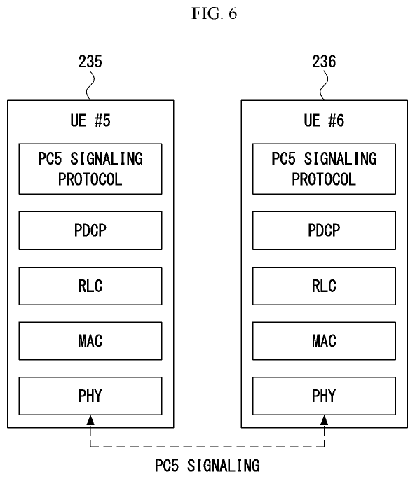

FIG. 5 is a block diagram illustrating a first exemplary embodiment of a control plane protocol stack of a UE performing sidelink communication, and FIG. 6 is a block diagram illustrating a second exemplary embodiment of a control plane protocol stack of a UE performing sidelink communication.

As shown in FIGS. 5 and 6, a left UE may be the UE 235 shown in FIG. 2 and a right UE may be the UE 236 shown in FIG. 2. The scenario for the sidelink communications between the UEs 235 and 236 may be one of the sidelink communication scenarios A through D of Table 1. The control plane protocol stack illustrated in FIG. 5 may be a control plane protocol stack for transmission and reception of broadcast information (e.g., Physical Sidelink Broadcast Channel (PSBCH)).

The control plane protocol stack shown in FIG. 5 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 6 may be a control plane protocol stack for one-to-one sidelink communication. The control plane protocol stack shown in FIG. 6 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by a higher layer signaling. The PSCCH may be used for transmitting and receiving sidelink control information (SCI) and may also be configured in the UE (e.g., UE 235 or 236) by a higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink TM | Description |
|---|---|
| 1 | Transmission using resources |
| | scheduled by base station |
| 2 | UE autonomous transmission |
| | without scheduling of base station |
| 3 | Transmission using resources scheduled |
| | by base station in V2X communications |
| 4 | UE autonomous transmission without |
| | scheduling of base station in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a UE #1 (e.g., vehicle #1) is described, a UE #2 (e.g., vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

In exemplary embodiments, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or SCI).

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The 1st-stage SCI may include or more information elements among priority information, frequency resource assignment information, time resource assignment information, resource reservation period information, demodulation reference signal (DMRS) pattern information, 2nd-stage SCI format information, a beta_offset indicator, the number of DMRS ports, and modulation and coding scheme (MCS) information. The 2nd-stage SCI may include one or more information elements among a HARQ processor identifier (ID), a redundancy version (RV), a source ID, a destination ID, CSI request information, a zone ID, and communication range requirements. The SCI format 2-C may be used for decoding of a PSSCH and/or providing inter-UE coordination information.

Meanwhile, a security function for user data and/or signaling data (e.g., system information, control information) may be provided in the communication system. In exemplary embodiments, data may refer to user data and/or signaling data. A base station may activate the security function. When the security function is activated by the base station, ‘communication between the base station and a UE’ and/or ‘communication between UEs’ may be performed based on the security function (e.g., flexible security function or adaptive security function). In exemplary embodiments, the security function may include at least one of an encryption function, an integrity function, or an electronic signature function. The encryption function may refer to an encryption operation for data based on an encryption algorithm. The integrity function may refer to an integrity operation for data based on an integrity algorithm. The electronic signature function may refer to an electronic signature operation for data based on an electronic signature algorithm. To support the above-described security function, communication nodes (e.g., base stations, UEs) may embed the encryption algorithm, integrity algorithm, and/or electronic signature algorithm. The encryption algorithm may include at least one of NEA0, 128-NEA1, 128-NEA2, or 128-NEA3. The integrity algorithm may include at least one of NIA0, 128-NIA1, 128-NIA2, or 128-NIA3.

In sidelink communication (e.g., V2X communication), a communication node (e.g., network entity) may perform an authentication operation for a source of received data. Data between communicating nodes may be protected by the encryption function, integrity function, and/or electronic signature function. The security requirement(s) for unicast mode, groupcast mode, and/or broadcast mode on a PC5 link may be defined as follows. In exemplary embodiment, a transmitting UE may be a UE that transmits data, and a receiving UE may be a UE that receives the data from the transmitting UE. O operations of the transmitting UE may be interpreted as operations of a vehicle in which the transmitting UE is located, and operations of the receiving UE may be interpreted as operations of a vehicle in which the receiving UE is located.

If a security function is activated in an establishment procedure of a PC5 unicast link, a transmitting UE may configure a different security context for each of receiving UEs.

Configuration of the security function for the PC5 unicast link between the transmitting UE and the receiving UE may be protected against ‘Man-In-The-Middle (MITM)’ attacks.

The communication system (e.g., 5G system, 6G system) may provide the encryption function and/or integrity function for user data of PC5 unicast, and may provide protection against security attacks (e.g., replaying attacks).

The communication system (e.g., 5G system, 6G system) may provide the encryption function and/or integrity function for control signaling of PC5 unicast, and may provide protection against security attacks (e.g., replay attacks).

The communication system (e.g., 5G system, 6G system) may provide users (e.g., UEs) with means for configuring security policies of user data and control signaling on the PC5 unicast link.

Control signaling protection for the PC5 unicast link may conform to a security policy of PC5 signaling between UEs.

User data protection for the PC5 unicast link may conform to a security policy of PC5 user data between UEs.

Meanwhile, it may be difficult to apply adaptive security that reflects a vehicle environment (e.g., communication environment) in V2X communication. In exemplary embodiment, a vehicle environment may refer to a communication environment. In order to apply information included in a message before occurrence of a risk situation, a transmitting UE (e.g., transmitting UE located in a vehicle) may transmit a protected message (e.g., secure message) within an appropriate time, and a receiving UE (e.g., receiving UE located in a vehicle) may process the protected message received from the transmitting UE within an appropriate time. According to the above-described operation, reliability of the vehicle may be ensured. For example, if a warning message is not properly processed in the vehicles (e.g., transmitting UE and/or receiving UE located in the vehicles) due to the vehicle environment, a driver of the vehicle may end up in a dangerous situation. For example, the vehicle environment may include a case when the vehicle (e.g., UE located in the vehicle) is located in an area with traffic congestion, a case when the vehicle (e.g., UE located in the vehicle) is moving at high speed, and/or a case when the vehicle (e.g., UE located in the vehicle) uses a high level of security function compared to available resources. That is, the vehicle environment may include at least one of a speed of the vehicle, degree of traffic congestion around the vehicle, available resources for application of a security function, security level of the vehicle, security level of a service, security level of a message, or importance of a message.

In the vehicle environment described above, the vehicle (e.g., transmitting UE and/or receiving UE located in the vehicle) may not be able to process the protected message (e.g., secure message) within a limited time. Because safety of the driver is more important than the security of message, ensuring that the vehicle processes the message within an appropriate time may be important. In order to solve the above-mentioned problem, a method of flexibly determining a security level depending on the vehicle environment, a method of applying the determined security level to the vehicle (e.g., UE located in the vehicle) within an appropriate time, and/or the like may be required.

In exemplary embodiments, parameters for the vehicle environment (e.g., communication environment) may be referred to as ‘vehicle_environment (V_E)’. V_E may be preset in the vehicle (e.g., UE). V_E may be defined (or used) based on preset criteria and/or rules. The use of V_E (e.g. use of a flexible security level or use of an adaptive security level) may be activated in an access procedure and/or authentication procedure between the vehicle (e.g. UE) and the communication system. In this case, V_E may be activated by an indication from a network entity (e.g., authentication management field (AMF), security anchor function (SeAF), etc.). Alternatively, the use of V_E may be activated by a base station. In this case, after the vehicle (e.g., UE) notifies the base station of initiation of a V2X service, the use of V_E may be activated by the base station. When a flexible security level (e.g., adaptive security level) is applied based on V_E, the transmitting UE may apply a security function according to the security level to data within an appropriate time and transmit the data. In addition, within an appropriate time, the receiving UE may process the data received from the transmitting UE based on a security function according to the security level and apply the processed data. According to the above-described operation, the safety of the vehicle and/or the safety of the driver can be ensured.

V_E may be parameter(s) that can determine the vehicle's surrounding environment (e.g., communication environment). When the use of V_E is activated, an appropriate security level may be applied based on V_E. The transmitting UE may identify a surrounding environment (e.g., surrounding environment of the vehicle in which the transmitting UE is located), determine an appropriate security level according to the identified surrounding environment (e.g., V_E), and process a message based on the determined security level. The receiving UE may identify a surrounding environment (e.g., surrounding environment of the vehicle in which the receiving UE is located), determine an appropriate security level according to the identified surrounding environment (e.g., V_E), and inform the determined security level to the transmitting UE. In this case, the transmitting UE may process a message based on the security level determined by the receiving UE.

In a link establishment procedure of sidelink communication (e.g., V2X communication), whether to apply a flexible security level (e.g., adaptive security level) may be indicated. For example, the transmitting UE or the receiving UE may indicate to the other UE whether to apply a flexible security level. The transmitting UE may determine an appropriate security level based on a surrounding environment (e.g., V_E), apply a security function according to the determined security level to data, and transmit information on the applied security level and the data to the receiving UE. The receiving UE may receive the information on the applied security level and the data from the transmitting UE, and may perform processing on the data based on the security level indicated by the transmitting UE.

Alternatively, the receiving UE may determine an appropriate security level based on a surrounding environment (e.g., V_E) and inform the transmitting UE of the determined security level. The transmitting UE may apply a security function to data according to the security level indicated by the receiving UE and transmit the data to the receiving UE. The receiving UE may receive the data from the transmitting UE and perform processing on the data based on the security level determined by the receiving UE.

According to the above-described operation, a flexible security level may be applied considering the vehicle environment. In this case, the transmitting UE and/or the receiving UE may process a message (e.g., V2X message, user data, signaling data) within an appropriate time. Accordingly, the safety of the vehicle and/or the safety of the driver can be ensured.

V_E may be used to determine the security level considering the vehicle environment (e.g., communication environment). V_E may be determined based on Equation 1 below. In Equation 1 below, the vehicle may refer to the transmitting UE and/or receiving UE located in the vehicle.

V_E=function (speed of the vehicle, degree of traffic congestion around the vehicle, available resources for applying a security function, security level of the vehicle, security level of a service, security level of a message, and/or importance of a message) Equation 1:

V_E may be determined based on the above-described factors and weights thereof. For example, V_E may be determined based on Equation 2 below. In Equation 2 below, the vehicle may refer to the transmitting UE and/or receiving UE located in the vehicle.

V_E=(α×speed of the vehicle)+(β×number of nearby vehicles)+(γ×CPU capability of a vehicle security system)+(δ×security level of the vehicle) Equation 2:

In Equation 2, each of α, β, γ, and δ may be set differently for each application. According to Equation 2, when the speed of the vehicle is high, the number of nearby vehicles is large, the CPU capability of the vehicle security system is high, and the security level of the vehicle is high, V_E may have a large value. A security level corresponding to V_E may be defined. That is, a mapping relationship between V_E and security levels may be established. For example, the base station may transmit a signaling message including information on the mapping relationship between V_E and security levels to the UE(s). The security level corresponding to V_E may be exchanged between the transmitting UE and the receiving UE through signaling (e.g., SCI, MAC CE). When the security level corresponding to V_E is determined by the transmitting UE, the transmitting UE may transmit a signaling message including information of the determined security level to the receiving UE. When the security level corresponding to V_E is determined by the receiving UE, the receiving UE may transmit a signaling message including information of the determined security level to the transmitting UE.

A higher layer (e.g., V2X layer and/or application layer) of the vehicle (e.g., transmitting UE or receiving UE) may calculate V_E based on Equation 1 or Equation 2, and deliver the calculated V_E to a lower layer of the vehicle. The lower layer of the vehicle may identify a security level corresponding to V_E received from the higher layer. V_E may be calculated in real time.

When the security level is determined by the transmitting UE, the transmitting UE may generate SCI including information (e.g., index) on the security level and transmit the SCI. The information on the security level may be represented in form of a bitmap within the SCI. The SCI may include scheduling information of data to which the security level is applied. The transmitting UE may generate the data based on the security level indicated by the SCI and transmit the data on a resource indicated by the SCI. The receiving UE may receive the SCI from the transmitting UE, identify the information on the security level included in the SCI, and determine that the security level is applied to the data scheduled by the SCI. The receiving UE may receive the data in the resource indicated by the SCI and perform processing on the data based on the security level indicated by the SCI.

When the security level is determined by the receiving UE, the receiving UE may transmit information (e.g., index) on the determined (i.e., preferred) security level to the transmitting UE. The information on the security level may be represent in form of a bitmap. The transmitting UE may receive the information on the security level from the receiving UE and perform a data transmission operation based on the security level. The type of encryption algorithm, the size of a key in the encryption algorithm, the type of decryption algorithm, the type of digital signature algorithm, and/or the size of a key in the digital signature algorithm may be set differently for each security level.

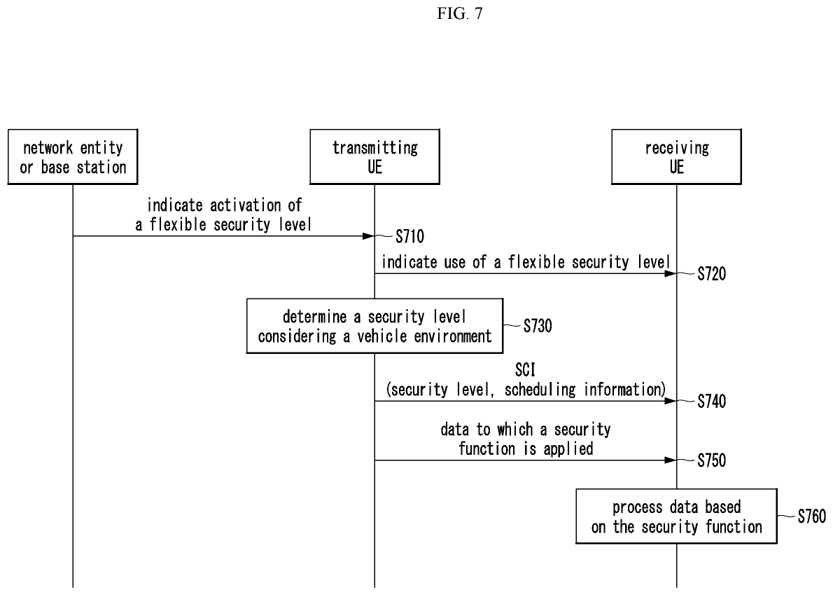

FIG. 7 is a sequence chart illustrating a first exemplary embodiment of a communication method based on a flexible security level.

As shown in FIG. 7, a network entity (e.g., AMF and/or SeAF) or base station may transmit information indicating activation of the use of a flexible security level (e.g., V_E) to a transmitting UE and/or receiving UE at S710. In an access procedure and/or authentication procedure of the communication system (e.g., communication network), the network entity may transmit information indicating activation of the use of a flexible security level to the transmitting UE and/or receiving UE. Alternatively, the transmitting UE may transmit sidelink UE information indicating initiation of a sidelink service (e.g., V2X service) to the base station, and the base station receiving the sidelink UE information may transmit an RRC connection reconfiguration message indicating activation of the use of a flexible security level to the transmitting UE and/or receiving UE. The transmitting UE and/or receiving UE may determine that use of a flexible security level is activated based on the information received from the network entity or base station. Alternatively, the transmitting UE may activate the use of a flexible security level on its own without an indication from the network entity and/or base station.

When the use of a flexible security level is activated, the transmitting UE may determine whether to use a flexible security level for data transmission. When it is determined that a flexible security level is used, the transmitting UE may transmit a signaling message indicating that a flexible security level is used to the receiving UE at S720. When it is determined that a flexible security level is not used, the step S720 may not be performed. The signaling message may be transmitted and received in a link establishment procedure between the transmitting UE and the receiving UE. The receiving UE may receive the signaling message from the transmitting UE, and based on the signaling message, the receiving UE may determine that a flexible security level is used in the transmitting UE.

When it is determined that a flexible security level is used, the transmitting UE may determine V_E considering a vehicle environment. V_E may be determined based on Equation 1 or Equation 2. The transmitting UE may determine a security level corresponding to V_E at S730. A mapping relationship between V_E and security levels may be configured in advance, and the transmitting UE may determine a security level corresponding to V_E based on the mapping relationship.

The transmitting UE may generate SCI including information on the security level and scheduling information of data to which the security level is applied, and transmit the SCI to the receiving UE at S740. The SCI may include first-stage SCI and second-stage SCI, the scheduling information of the data may be included in the first-stage SCI, and the information on the security level may be included in the second-stage SCI associated with the first-stage SCI. Alternatively, the scheduling information of the data and the information on the security level may be included in the first-stage SCI. The information on the security level included in the SCI may imply the use of a flexible security level. In this case, the step S720 may be omitted. The transmitting UE may generate the data based on the security level indicated by the SCI (e.g., the security level determined in the step S730) and transmit the data to the receiving UE in a resource indicated by the scheduling information included in the SCI at S750. A security function (e.g., encryption function, integrity function, and/or electronic signature function) depending on the security level may be applied to the data.

The receiving UE may receive the SCI from the transmitting UE and identify information elements (e.g., information of the security level, scheduling information) included in the SCI. When the SCI includes the information on the security level, the receiving UE may determine that a flexible security level is used. The receiving UE may receive the data from the transmitting UE in the resource indicated by the scheduling information included in the SCI, and perform a processing operation (e.g., decryption operation, integrity verification operation, and/or electronic signature verification operation) on the data based on a security function according to the security level indicated by the SCI at S760.

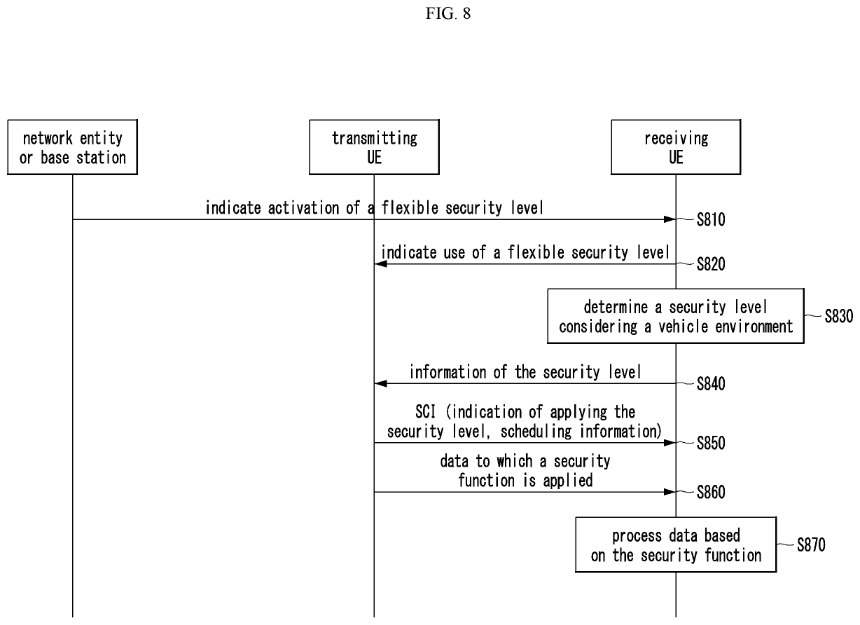

FIG. 8 is a sequence chart illustrating a second exemplary embodiment of a communication method based on a flexible security level.

As shown in FIG. 8, a network entity (e.g., AMF and/or SeAF) or base station may transmit information indicating activation of the use of a flexible security level (e.g., V_E) to a transmitting UE and/or receiving UE at S810. In an access procedure and/or authentication procedure of the communication system (e.g., communication network), the network entity may transmit information indicating activation of the use of a flexible security level to the transmitting UE and/or receiving UE. Alternatively, the receiving UE may transmit sidelink UE information indicating initiation of a sidelink service (e.g., V2X service) to the base station, and the base station receiving the sidelink UE information may transmit an RRC connection reconfiguration message indicating activation of the use of a flexible security level to the transmitting UE and/or receiving UE. The transmitting UE and/or receiving UE may determine that use of a flexible security level is activated based on the information received from the network entity or base station. Alternatively, the receiving UE may activate the use of a flexible security level on its own without an indication from the network entity and/or base station.

When the use of a flexible security level is activated, the receiving UE may determine whether to use a flexible security level for data transmission. When it is determined that a flexible security level is used, the receiving UE may transmit a signaling message indicating that a flexible security level is used to the transmitting UE at S820. When it is determined that a flexible security level is not used, the step S820 may be omitted. The signaling message may be transmitted and received in a link establishment procedure between the transmitting UE and the receiving UE. The transmitting UE may receive the signaling message from the receiving UE, and based on the signaling message, the transmitting UE may determine that a flexible security level is used in the receiving UE.

When it is determined that a flexible security level is used, the receiving UE may determine V_E considering a vehicle environment. V_E may be determined based on Equation 1 or Equation 2. The receiving UE may determine a security level corresponding to V_E at S830. A mapping relationship between V_E and security levels may be configured in advance, and the receiving UE may determine a security level corresponding to V_E based on the mapping relationship. The receiving UE may transmit a signaling message including information on the security level (e.g., preferred security level) to the transmitting UE at S840. The transmitting UE may receive the signaling message from the receiving UE and may identify the security level preferred by the receiving UE based on the information included in the signaling message. The information on the security level included in the signaling message may imply the use of a flexible security level. In this case, the step S820 may be omitted.

The transmitting UE may generate SCI including information indicating that the security level indicated by the receiving UE is applied and scheduling information of data to which the security level is applied, and transmit the SCI to the receiving UE at S850. The SCI may include first-stage SCI and second-stage SCI, the scheduling information of data may be included in the first-stage SCI, and the information indicating that the security level indicated by the receiving UE is applied may be included in the second-stage SCI associated with the first-stage SCI. Alternatively, the scheduling information of data and the information indicating that the security level indicated by the receiving UE is applied may be included in the first-stage SCI. The transmitting UE may generate the data based on the security level indicated by the receiving UE and transmit the data to the receiving UE in a resource indicated by the scheduling information included in the SCI at S860. A security function (e.g., encryption function, integrity function, and/or electronic signature function) depending on the security level may be applied to the data.

The receiving UE may receive the SCI from the transmitting UE and identify information elements included in the SCI. When the SCI includes the information indicating that the security level indicated by the receiving UE is applied, the receiving UE may determine that the security level preferred by itself is to be used. The receiving UE may receive the data from the transmitting UE in the resource indicated by the scheduling information included in the SCI, and perform a processing operation (e.g., decryption operation, integrity verification operation, and/or electronic signature verification operation) on the data based on a security function according to the security level determined by the receiving UE at S870.

Meanwhile, if it is difficult to use the security level determined by the receiving UE, the transmitting UE may determine a security level by considering a vehicle environment. That is, the security level determined by the transmitting UE may be different from the security level determined in the step S830. In this case, the SCI transmitted in the step S850 may include information on the security level determined by the transmitting UE instead of the information indicating that the security level indicated by the receiving UE is applied. In the step S860, the transmitting UE may generate the data based on a security function according to the security level determined by the transmitting UE and transmit the data to the receiving UE. The receiving UE may receive the SCI from the transmitting UE. When the SCI does not include the information indicating that the security level indicated by the receiving UE is applied, the receiving UE may determine that the data scheduled by the SCI has been generated based on the security level determined by the transmitting UE instead of the security level determined by the receiving UE. Accordingly, the receiving UE may perform a processing operation on the data based on the security level indicated by the SCI (i.e., the security level determined by the transmitting UE).

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

1. A method of operation of a first user equipment (UE), comprising:
determining a security level based on a communication environment;
transmitting sidelink control information (SCI) including information on the security level and scheduling information of data to a second UE;
generating the data based on a security function according to the security level; and
transmitting the data to the second UE in a resource indicated by the scheduling information.

2. The method according to claim 1, further comprising: receiving, from a network entity or base station, information indicating activation of use of a flexible security level, wherein when the use of the flexible security level is activated, the security level is determined based on the communication environment.

3. The method according to claim 2, wherein the information indicating activation of use of the flexible security level is received from the network entity in a network access procedure or a network authentication procedure.

4. The method according to claim 2, wherein receiving the information indicating activation of use of the flexible security level comprises:
transmitting information indicating initiation of a sidelink service to the base station; and
receiving, from the base station, a radio resource control (RRC) message including the information indicating activation of use of the flexible security level.

5. The method according to claim 1, further comprising: transmitting, to the second UE, information indicating use of a flexible security level, wherein the information indicating use of the flexible security level is transmitted in a link establishment procedure between the first UE and the second UE.

6. The method according to claim 1, further comprising: identifying the communication environment, wherein a mapping relationship between the communication environment and the security level is configured in advance, and the security level is determined based on the mapping relationship with the communication environment.

7. The method according to claim 1, wherein the communication environment includes at least one of a speed of the first UE, a degree of traffic congestion around the first UE, available resources for application of the security function according to the security level, a security level of the first UE, a security level of a service, a security level of a message, or importance of a message.

8. The method according to claim 1, wherein the security function includes at least one of an encryption function, an integrity function, or an electronic signature function.

9. The method according to claim 1, wherein the SCI is classified into first-stage SCI and second-stage SCI, the scheduling information is included in the first-stage SCI, and the information on the security level is included in the second-stage SCI associated with the first-stage SCI.

10. A method of operation of a first user equipment (UE), comprising:
receiving information on a security level from a second UE;
transmitting sidelink control information (SCI) including information indicating application of the security level and scheduling information of data to the second UE;
generating the data based on a security function according to the security level; and
transmitting the data to the second UE in a resource indicated by the scheduling information.

11. The method according to claim 10, further comprising: receiving, from a network entity or base station, information indicating activation of use of a flexible security level, wherein when the use of the flexible security level is activated, sidelink communication based on the security level determined by the second UE is performed.

12. The method according to claim 10, further comprising: receiving, from the second UE, information indicating use of a flexible security level, wherein the information indicating use of the flexible security level is received in a link establishment procedure between the first UE and the second UE.

13. The method according to claim 10, wherein the security level is determined by the second UE considering a communication environment, and the communication environment includes at least one of a speed of the second UE, a degree of traffic congestion around the second UE, available resources for application of the security function according to the security level, a security level of the second UE, a security level of a service, a security level of a message, or importance of a message.

14. A method of operation of a second user equipment (UE), comprising:
determining a security level considering a communication environment;
transmitting information on the security level to a first UE;
receiving sidelink control information (SCI) including information indicating application of the security level and scheduling information of data from the first UE;
receiving the data from the first UE in a resource indicated by the scheduling information; and
performing a processing operation on the data based on a security function according to the security level.

15. The method according to claim 14, further comprising: receiving, from a network entity or base station, information indicating activation of use of a flexible security level, wherein when the use of the flexible security level is activated, the security level is determined based on the communication environment.

16. The method according to claim 15, wherein the information indicating activation of use of the flexible security level is received from the network entity in a network access procedure or a network authentication procedure.

17. The method according to claim 15, wherein the receiving of the information indicating activation of use of the flexible security level comprises:
transmitting information indicating initiation of a sidelink service to the base station; and
receiving, from the base station, a radio resource control (RRC) message including the information indicating activation of use of the flexible security level.

18. The method according to claim 14, further comprising: identifying the communication environment, wherein a mapping relationship between the communication environment and the security level is configured in advance, and the security level is determined based on the mapping relationship with the communication environment.

19. The method according to claim 14, wherein the communication environment includes at least one of a speed of the second UE, a degree of traffic congestion around the second UE, available resources for application of the security function according to the security level, a security level of the second UE, a security level of a service, a security level of a message, or importance of a message.

20. The method according to claim 14, wherein the processing operation includes at least one of a decryption operation, an integrity verification operation, or an electronic signature verification operation.
